(19) United States
(12) Patent Application Publication
(10) Pub. No.: US 2016/0036775 A1
(43) Pub. Date: Feb. 4, 2016

(54) DATA PROCESSING SYSTEM

(71) Applicant: Edward Brian Depenbrock, Coral Springs, FL (US)

(72) Inventor: Edward Brian Depenbrock, Coral Springs, FL (US)

(21) Appl. No.: 14/465,143

(22) Filed: Aug. 21, 2014

Related U.S. Application Data
(63) Continuation-in-part of application No. 14/449,883, filed on Aug. 1, 2014.
Application No. 14/449,883 is a continuation-in-part of application No. 14/449,794, filed on Aug. 1, 2014.

(51) Int. Cl. H04L 29/12; H04L 29/08; G06F 3/0484

(52) U.S. Cl. CPC H04L 61/30; G06F 3/0484; H04L 67/306

(57) ABSTRACT

A method, computer program product, and computing system for rendering an alias configuration window for defining an alias that is linked to/associated with a user profile for a user of a dating website. One or more alias selections are received from the alias configuration window concerning the alias that is linked to/associated with the user profile for the user of the dating website. The alias is generated that includes the one or more alias selections received from the alias configuration window.

### RELATED APPLICATION(S)

This application is a Continuation-in-Part application and claims the priority of the following U.S. patent applications, each of which is herein incorporated by reference in its entirety: U.S. patent application Ser. No. 14/449,883, filed on 1 Aug. 2014 and entitled “Data Processing System” and U.S. patent application Ser. No. 14/449,794, filed on 1 Aug. 2014 and entitled “Data Processing System”.

### TECHNICAL FIELD

This disclosure relates to defining data and, more particularly, to defining data associated with a user profile.

### BACKGROUND

When users join various social websites (e.g., social networking websites, dating websites, merchandising websites), these users may be required to define a profile that identifies their various preferences. For social networking websites, these preferences may concern their interest in music and food. For dating websites, these preferences may concern the physical description of the user and their preferences for a mate. For merchandising websites, these preferences may concern shipping options and payment options.

While certain types of information within a user profile may require definitive choices and may be objectively definable (the height of a user), other types need/may not be. For example and with respect to some types of information (especially those types of information that do not concern physical characteristics and concern e.g., personal preferences/choices/interests), the user may wish to vary their preferences/responses depending upon the specific interest/situation/condition.

Unfortunately, when users define a profile, they may be required to make specific choices that may not be true all of the time (e.g., the geographic location of a person that travels a lot). Accordingly and to address such a situation, the user may be required to set up multiple user profiles (and expanded considerable time managing those multiple user profiles).

### SUMMARY OF DISCLOSURE

In one implementation, a computer-implemented method, executed on a computing system, includes rendering an alias configuration window for defining an alias that is linked to/associated with a user profile for a user of a dating website. One or more alias selections are received from the alias configuration window concerning the alias that is linked to/associated with the user profile for the user of the dating website. The alias is generated that includes the one or more alias selections received from the alias configuration window.

One or more of the following features may be included. A profile configuration window may be rendered for defining the user profile for the user of the dating website. One or more profile selections may be received from the profile configuration window concerning the user profile for the user of the dating website. The user profile may be generated that includes the one or more profile selections received from the profile configuration window. The dating website may be a swinger's website. The user profile may define a group of people. The user profile may define a single person.

In another implementation, a computer program product resides on a computer readable medium that has a plurality of instructions stored on it. When executed by a processor, the instructions cause the processor to perform operations including rendering an alias configuration window for defining an alias that is linked to/associated with a user profile for a user of a dating website. One or more alias selections are received from the alias configuration window concerning the alias that is linked to/associated with the user profile for the user of the dating website. The alias is generated that includes the one or more alias selections received from the alias configuration window.

One or more of the following features may be included. A profile configuration window may be rendered for defining the user profile for the user of the dating website. One or more profile selections may be received from the profile configuration window concerning the user profile for the user of the dating website. The user profile may be generated that includes the one or more profile selections received from the profile configuration window. The dating website may be a swinger's website. The user profile may define a group of people. The user profile may define a single person.

In another implementation, a computing system includes at least one processor and at least one memory architecture coupled with the at least one processor, wherein the computing system is configured to perform operations including rendering an alias configuration window for defining an alias that is linked to/associated with a user profile for a user of a dating website. One or more alias selections are received from the alias configuration window concerning the alias that is linked to/associated with the user profile for the user of the dating website. The alias is generated that includes the one or more alias selections received from the alias configuration window.

One or more of the following features may be included. A profile configuration window may be rendered for defining the user profile for the user of the dating website. One or more profile selections may be received from the profile configuration window concerning the user profile for the user of the dating website. The user profile may be generated that includes the one or more profile selections received from the profile configuration window. The dating website may be a swinger's website. The user profile may define a group of people. The user profile may define a single person.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a distributed computing network including a computing device that executes a data process according to an implementation of the present disclosure;

FIG. 2 is a flowchart of the data process of FIG. 1 according to an implementation of the present disclosure;

FIG. 3 is a diagrammatic view of a profile configuration window rendered by the data process of FIG. 1 according to an implementation of the present disclosure;

FIG. 4A is a diagrammatic view of a profile rendered by the data process of FIG. 1 according to an implementation of the present disclosure;

FIG. 4B is a diagrammatic view of an alias configuration window rendered by the data process of FIG. 1 according to an implementation of the present disclosure; and

FIG. 4C is a diagrammatic view of an alias rendered by the data process of FIG. 1 according to an implementation of the present disclosure.

Like reference symbols in the various drawings indicate like elements.

### DETAILED DESCRIPTION OF THE PREFERRED EMBODIMENTS

### System Overview

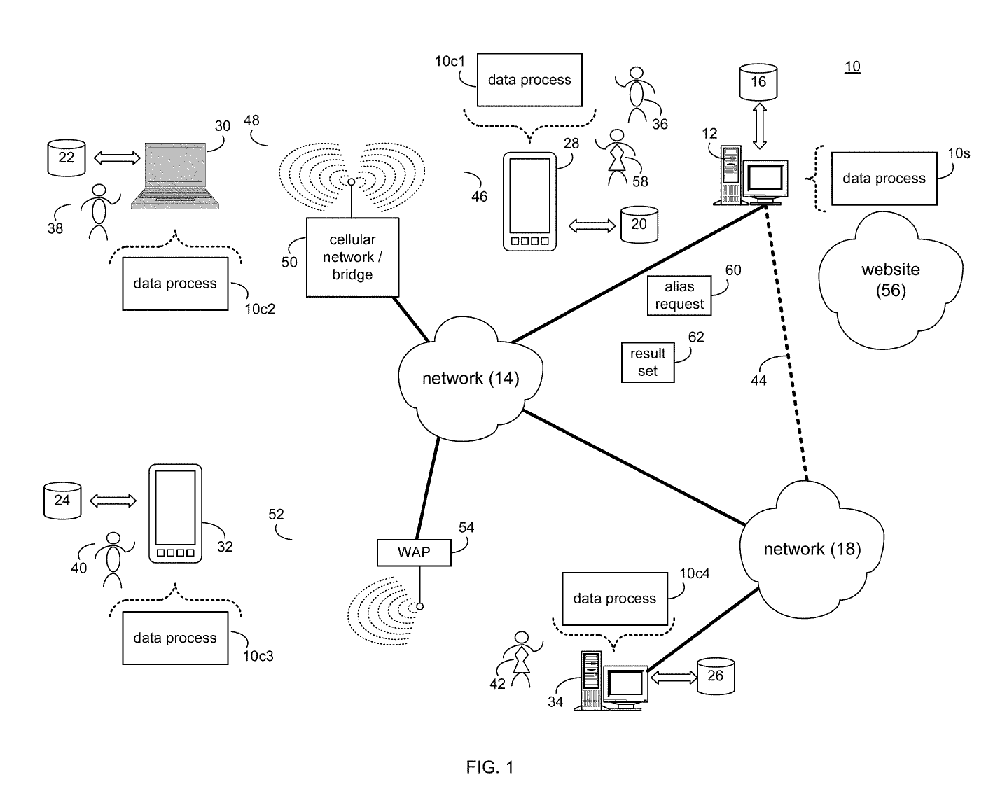

Referring to FIG. 1, there is shown data process 10. As will be discussed below in greater detail, data process 10 may be utilized to process data received from e.g., a first user and present that data to e.g., a second user.

Data process 10 may be implemented as a server-side process, a client-side process, or a hybrid server-side/client-side process. For example, data process 10 may be implemented as a purely server-side process via data process 10s. Alternatively, data process 10 may be implemented as a purely client-side process via one or more of client-side process 10c1, client-side process 10c2, client-side process 10c3, and client-side process 10c4. Alternatively still, data process 10 may be implemented as a hybrid server-side/client-side process via data process 10s in combination with one or more of client-side process 10c1, client-side process 10c2, client-side process 10c3, and client-side process 10c4. Accordingly, data process 10 as used in this disclosure may include any combination of data process 10s, client-side process 10c1, client-side process 10c2, client-side process 10c3, and client-side process 10c4.

Data process 10s may be a server application and may reside on and may be executed by computing device 12, which may be connected to network 14 (e.g., the Internet or a local area network). Examples of computing device 12 may include, but are not limited to: a personal computer, a laptop computer, a personal digital assistant, a data-enabled cellular telephone, a notebook computer, a television with one or more processors embedded therein or coupled thereto, a cable/satellite receiver with one or more processors embedded therein or coupled thereto, a server computer, a series of server computers, a mini computer, a mainframe computer, or a dedicated network device.

The instruction sets and subroutines of data process 10s, which may be stored on storage device 16 coupled to computing device 12, may be executed by one or more processors (not shown) and one or more memory architectures (not shown) included within computing device 12. Examples of storage device 16 may include but are not limited to: a hard disk drive; a tape drive; an optical drive; a RAID device; a random access memory (RAM); a read-only memory (ROM); and all forms of flash memory storage devices.

Network 14 may be connected to one or more secondary networks (e.g., network 18), examples of which may include but are not limited to: a local area network; a wide area network; or an intranet, for example.

Examples of client-side processes 10c1, 10c2, 10c3, 10c4 may include but are not limited to a web browser, a game console user interface, or a specialized application (e.g., an application running on e.g., the Android™ platform or the iPhone™ platform). The instruction sets and subroutines of client-side applications 10c1, 10c2, 10c3, 10c4, which may be stored on storage devices 20, 22, 24, 26 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Examples of storage devices 20, 22, 24, 26 may include but are not limited to: hard disk drives; tape drives; optical drives; RAID devices; random access memories (RAM); read-only memories (ROM), and all forms of flash memory storage devices.

Examples of client electronic devices 28, 30, 32, 34 may include, but are not limited to, data-enabled, cellular telephone 28, laptop computer 30, personal digital assistant 32, personal computer 34, a notebook computer (not shown), a server computer (not shown), a gaming console (not shown), a smart television (not shown), and a dedicated network device (not shown). Client electronic devices 28, 30, 32, 34 may each execute an operating system, examples of which may include but are not limited to Microsoft Windows™, Android™, WebOS™, iOS™, Redhat Linux™, or a custom operating system.

Users 36, 38, 40, 42 may access data process 10 directly through network 14 or through secondary network 18. Further, data process 10 may be connected to network 14 through secondary network 18, as illustrated with link line 44.

The various client electronic devices (e.g., client electronic devices 28, 30, 32, 34) may be directly or indirectly coupled to network 14 (or network 18). For example, data-enabled, cellular telephone 28 and laptop computer 30 are shown wirelessly coupled to network 14 via wireless communication channels 46, 48 (respectively) established between data-enabled, cellular telephone 28, laptop computer 30 (respectively) and cellular network/bridge 50, which is shown directly coupled to network 14. Further, personal digital assistant 32 is shown wirelessly coupled to network 14 via wireless communication channel 52 established between personal digital assistant 32 and wireless access point (i.e., WAP) 54, which is shown directly coupled to network 14. Additionally, personal computer 34 is shown directly coupled to network 18 via a hardwired network connection.

WAP 54 may be, for example, an IEEE 802.11a, 802.11b, 802.11g, 802.11n, Wi-Fi, and/or Bluetooth device that is capable of establishing wireless communication channel 52 between personal digital assistant 32 and WAP 54. As is known in the art, IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### Data Process:

Assume for illustrative purposes that user 36 would like to join website 56. Examples of website 56 may include any form of network that members may join so that they may interact in some fashion. An example of website 56 may include a traditional social networking website in which members post updates concerning their personal life, exchange personal photos, and voice political opinions. Another example of website 56 may include a dating website in which members generate a profile for themselves and review profiles of other members to determine who they would like to contact. An additional example of website 56 may include an ecommerce website in which members define a profile (e.g., that identifies shipping addresses and payment methods) so that they may purchase merchandise online.

While the following example concerns website 56 being an alternative lifestyle website (specifically, a swingers website), this is for illustrative purposes only and is not intended to be a limitation of this disclosure, as other configurations are possible (such as the above-described ecommerce website and social networking website).

As is known in the art, a swingers website is a website in which members (typically as couples) communicate and interact with each other so that they may engage in sexual encounters. For example, a husband and wife may become members of a swingers website, where each of these individuals defines a profile and these two profiles may be linked as a couple. Additionally, the swingers website (e.g., website 56) may be configured to allow individuals to join (thus not requiring individuals to join as couples).

Once the above-described profiles are established, the various members of the swingers website (e.g., website 56) may search the profiles of the other members of the swingers website to identify other couples/individuals with whom they would like to communicate and possibly engage in sexual encounters. For example, a male/female couple may wish to interact with another male/female couple. Alternatively, a male/female couple may wish to interact with a male individual . . . or may wish to interact with a female individual.

Data process 10 may be configured to allow e.g., user 36 to define the above-described user profile. Data process 10 may be a stand-alone process that is configured to interact with website 56. Alternatively, data process 10 may be a portion of/built into website 56.

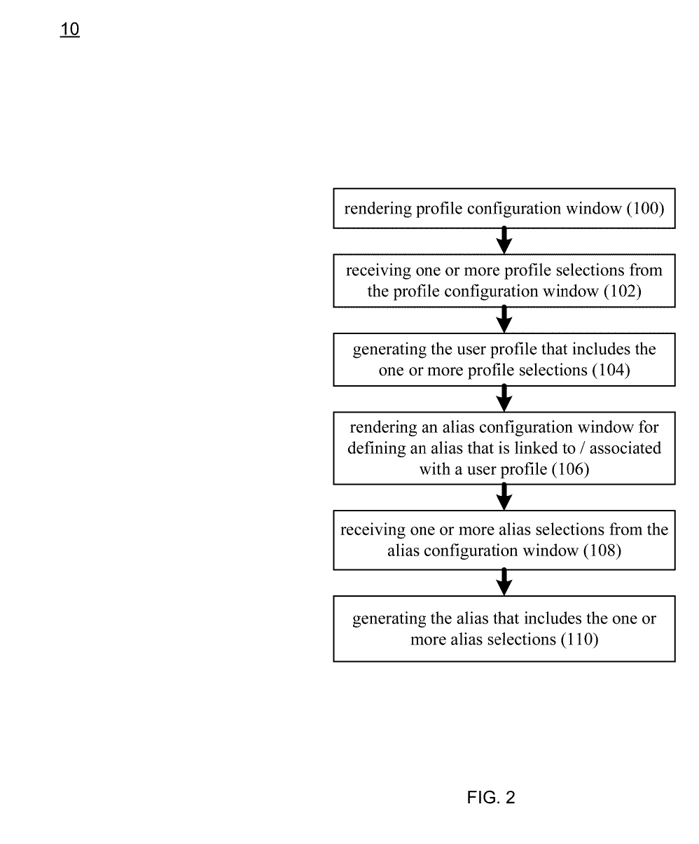

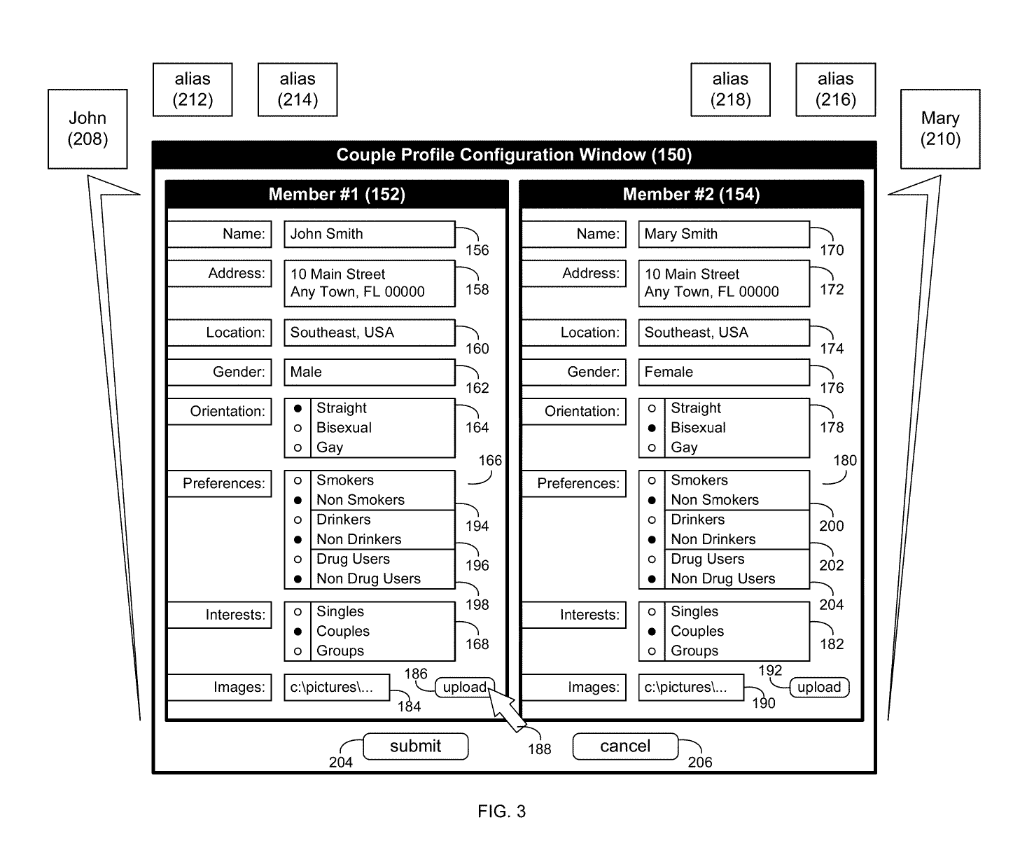

Referring also to FIGS. 2-3, data process 10 may be configured to render 100 profile configuration window 150 that may be configured to allow (in this example) user 36 to define a user profile within profile definition window 152 for use with the swingers website (e.g., website 56). Assume for illustrative purposes that the wife of user 36 (e.g., user 58) would also like to establish a user profile within profile definition window 154 for use within the swingers website (e.g., website 56).

For example and when rendering 100 profile configuration window 150, data process 10 may be configured to allow user 36 to define within profile definition window 152 a user name (within name field 156); a user address (within address field 158); a user location (within location field 160); a user gender (within gender field 162); a user sexual orientation (within orientation field 164); user preferences (within preferences field 166); and user interests (within interests field 168).

Further and when rendering 100 profile configuration window 150, data process 10 may be configured to allow user 58 (e.g., the wife of user 36) to define within profile definition window 154 a user name (within name field 170); a user address (within address field 172); a user location (within location field 174); a user gender (within gender field 176); a user sexual orientation (within orientation field 178); user preferences (within preferences field 180); and user interests (within interests field 182).

Profile configuration window 150 may also be configured (by data process 10) to allow user 36 and/or user 58 to upload one or more images for use within profile definition windows 152, 154 (respectively). For example, user 36 may locate an image file to be uploaded to website 58 within file location window 184 and, once located, may select “upload” button 186 using pointer 188 (controllable by e.g., a mouse; not shown). Further, user 58 may locate an image file to be uploaded to website 58 within file location window 190 and, once properly located, may select “upload” button 192 using pointer 188.

Data process 10 may render a plurality of mutually-exclusive descriptors for use by users (e.g., users 36, 58) of the swingers website (e.g., website 56).

One example of data process 10 rendering such mutually-exclusive descriptors for use by users (e.g., users 36, 58) of the swingers website (e.g., website 56) may include mutually-exclusive descriptors concerning sexual orientation.

For example and as discussed above, profile configuration window 150 may allow user 36 to define their sexual orientation within orientation field 164 and may allow user 58 to define their sexual orientation within orientation field 178. These descriptors may be considered mutually exclusive, in that data process 10 may be configured to allow a person to identify themselves as straight, bisexual, or gay.

Specifically, assume that user 36 (who is male) is only interested in sexual encounters with women. Accordingly, user 36 may define themselves as “straight” within orientation field 164. However, if user 58 (who is female) is interested in sexual encounters with men and/or women, user 58 may define themselves as “bisexual” within orientation field 178.

Another example of data process 10 rendering such mutually-exclusive descriptors for use by the users (e.g., users 36, 58) of the swingers website (e.g., website 56) may include mutually-exclusive descriptors concerning user preferences. For example: within preferences field 166, there are three subfields 194, 196, 198; and within preferences field 180, there are three subfields 200, 202, 204.

In this example, subfields 194, 200 concern smoking; subfields 196, 202 concern drinking; and subfields 198, 204 concern drug use. Within each of these subfields (and in this example) are two mutually-exclusive descriptors (e.g., smoker/non-smoker, drinker/non-drinker, user/non-user). Since these descriptors may be considered mutually exclusive, data process 10 may be configured to allow a person to only choose one of the mutually-exclusive descriptor pairs, thus defining a user preference for smokers or non-smokers, drinkers or non-drinkers, and users or non-users.

A third example of data process 10 rendering such mutually-exclusive descriptors for use by users (e.g., users 36, 58) of the swingers website (e.g., website 56) may include mutually-exclusive descriptors concerning user interests.

In this example, interest fields 168, 182 concern (in this example) the type of sexual encounters that users 36, 58 (respectively) may be interested in (via the mutually-exclusive descriptors singles, couples, groups). Again, since these descriptors may be considered mutually exclusive, data process 10 may be configured to allow a person to only choose one of the mutually-exclusive descriptors, thus defining a user interest in singles, couples or groups.

Once user 36 and/or user 58 have finalized their profile selections (e.g., within profile definition window 152, 154 respectively), user 36 and/or user 58 may select “submit” button 204 using pointer 188 (controllable by e.g., a mouse; not shown). Alternatively, user 36 and/or user 58 may select “cancel” button 206 using pointer 188.

Once user 36 and/or user 58 selects “submit” button 204, data process 10 may receive 102 the profile selections from the user (users 36, 58). Upon receiving 102 the above-described profile selections from the user(s), data process 10 may generate 104 user profile(s) that include the profile selections made by the user(s) and are accessible by the swingers website (e.g., website 56). For example, the profile selections made by user 36 within profile definition window 152 may be included within user profile 208 generated 104 by data process 10 for user 36. Further, the profile selections made by user 58 within profile definition window 154 may be included within user profile 210 generated 104 by data process 10 for user 58.

While the data process 10 is described above as generating 104 two profiles (e.g., profiles 208, 210 for users 36, 58 (respectively) that are linked together as a couple), this is for illustrative purposes only, as other configurations are possible and are considered to be within the scope of this disclosure. For example, data process 10 may be configured to generate 104 a “couple” user profile that describes the two individuals (e.g., user 36, 58) that are included in the couple.

Additionally, data process 10 may be configured to allow the users (e.g., users 36, 58) of the swingers website (e.g., website 56) to generate one or more aliases that may be associated with (in this example) user profiles 208, 210. As will be discussed below in greater detail, these aliases may be variations of a user profile, wherein the aliases may be linked to (i.e., associated with) the user profile.

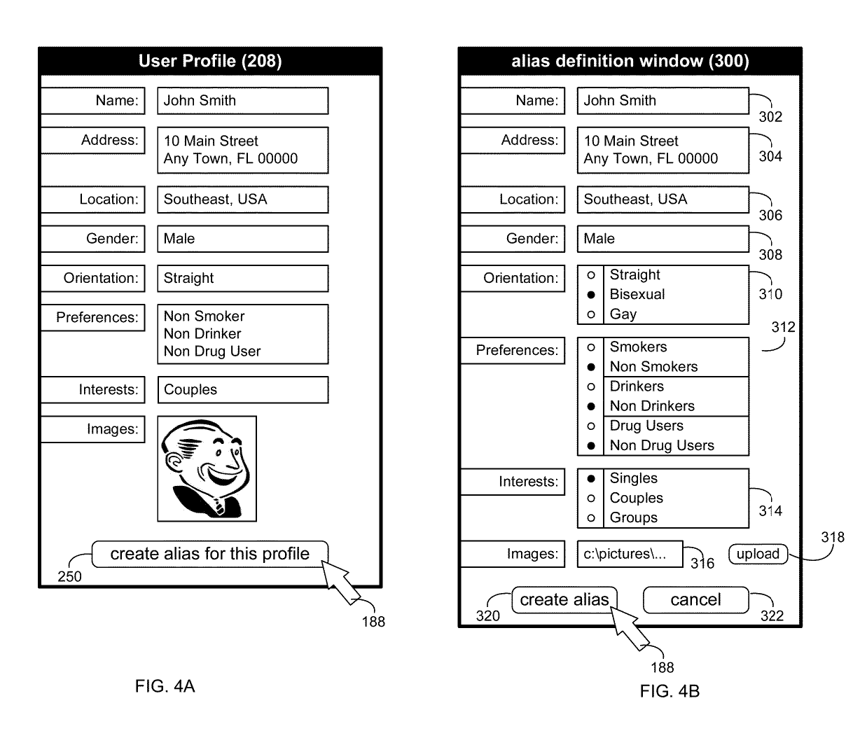

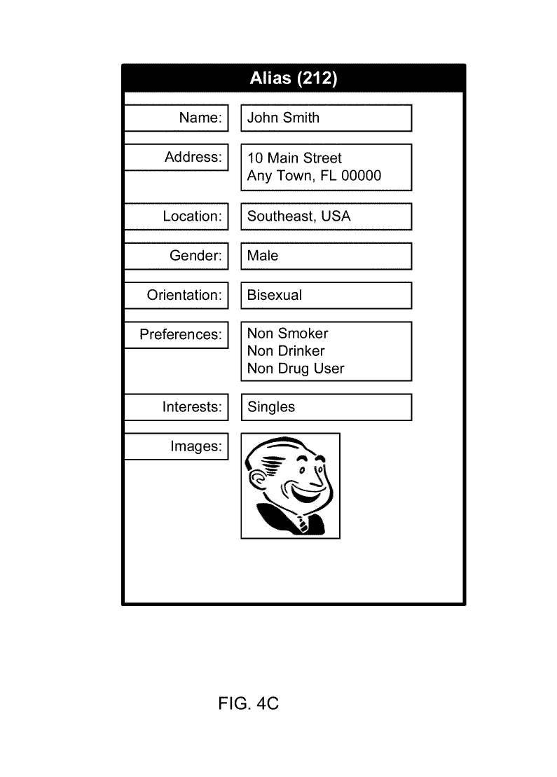

Accordingly and referring also to FIG. 4A, data process 10 may be configured to render “create alias for this profile” button 250, which may be selectable by (in this example) user 36 using pointer 188 (controllable by e.g., a mouse; not shown). Assume for illustrative purposes that user 36 wishes to create an alias (e.g., alias 212) for their profile (e.g., user profile 208).

Therefore and referring also to FIG. 4B, user 36 may select “create alias for this profile” button 250, resulting in the generation of alias request 60. Upon receiving alias request 60, data process 10 may render 106 alias definition window 300 that may be configured to allow (in this example) user 36 to define an alias linked to/associated with (in this example) user profile 208 for use within the swingers website (e.g., website 56).

In a fashion similar to profile definition window 152, alias definition window 300 may include a plurality of fields, examples of which may include but are not limited to a user name (within name field 302); a user address (within address field 304); a user location (within location field 306); a user gender (within gender field 308); a user sexual orientation (within orientation field 310); user preferences (within preferences field 312); and user interests (within interests field 314). Alias definition window 300 may also be configured (by data process 10) to allow user 36 to upload one or more images for association with the alias being generated. For example, user 36 may locate an image file to be uploaded for (in this example) alias 212 within file location window 316 and, once located, may select “upload” button 318 using pointer 188 (controllable by e.g., a mouse; not shown).

For this example and for alias 212, assume that user 36 wants to define their sexual orientation (within orientation field 310) as bisexual and wants to define their user interests (within interests field 314) as “singles”.

Once user 36 has finalized their alias selections within e.g., alias definition window 300, user 36 may select “create alias” button 320 using pointer 188. Alternatively, user 36 may select “cancel” button 322 using pointer 188.

Once user 36 selects “create alias” button 320, data process 10 may receive 108 the alias selections from user 36. Upon receiving 108 the above-described alias selections from the user, data process 10 may generate 110 alias 212 (as shown in FIG. 4C) that includes the alias selections made by user 36 and are accessible by the swingers website (e.g., website 56).

Additionally, data process 10 may be configured to allow user 36 to generate 110 a second alias (e.g., alias 214) that e.g., basically mimics profile 208 but defines the location and address of user 36 as Seattle, Wash. (where user 36 went to college).

Further, data process 10 may be configured to allow user 58 to generate 110 a first alias (e.g., alias 216) that e.g., basically mimics profile 210 but defines the sexual orientation of user 58 as straight. And data process 10 may be configured to allow user 58 to generate 110 a second alias (e.g., alias 218) that e.g., basically mimics profile 210 but defines the location and address of user 58 as Chicago, Ill. (where user 58 frequently travels to on business).

By allowing (in this example) users 36, 58 to generate 110 one of more aliases, a higher level of convenience may be provided to users 36, 58, as these users are provided with a higher level of flexibility concerning the manner in which they describe themselves (without requiring the user to set up multiple user accounts). Further, by associating the aliases with the primary profile (e.g., user profile 208 for user 36 and user profile 210 for user 58), data process 10 may be configured to allow the user to monitor and manage their user profile and all of their aliases by simply logging into one account.

For example, when user 36 logs into the user account associated with user profile 208, data process 10 may be configured so that all communications from third parties concerning aliases 212, 214 are routed to the user account associated with user profile 208. Accordingly, user 36 may monitor user profile 208, alias 212 and alias 214 by simply monitoring user profile 208. Further, when user 58 logs into the user account associated with user profile 210, data process 10 may be configured so that all communications from third parties concerning aliases 216, 218 are routed to the user account associated with user profile 210. Accordingly, user 58 may monitor user profile 210, alias 216 and alias 218 by simply monitoring user profile 210.

Data process 10 may be configured to receive search requests concerning the swingers website (e.g., website 56) and to generate result sets based upon the search criteria included in the search requests received.

Continuing with the above-stated example, assume that user 38 is a non-smoking, non-drinking, female who is interested in a sexual encounter with a couple including a straight male and a bisexual female. Accordingly, user 38 may enter a search request in a search screen (not shown) effectuated by data process 10 and included within the swingers website (e.g., website 56). For the following example, assume that user 38 defines a search request seeking a couple (including a straight male and a bisexual female) that prefers non-smokers/non-drinkers/non drug users and seeks encounters with singles that are located within the State of Florida.

Data process 10 may receive the above-described search request from user 38 and may compare the above-described search criteria (e.g., a couple that includes a straight male and a bisexual female that prefers non-smokers/non-drinkers/non drug users and seeks encounters with singles that are located within the State of Florida) to a plurality of user profiles (e.g., the user profiles included within the swingers website (e.g., website 56) including, but not limited to, user profiles 208. 210) and a plurality of aliases (e.g., the aliases included within the swingers website (e.g., website 56) including, but not limited to, aliases 212, 214, 216, 218) to generate a result set (e.g., result set 62) of user profiles/aliases. Assume for illustrative purposes that user profiles 208. 210 are included within result set 62.

Data process 10 may provide result set 62 to the user requesting the search (e.g., user 38) so that e.g., user 38 may review the user profiles/aliases (e.g., user profiles 208, 210) included within result set 62 to determine whether they would like to initiate contact with any of the people identified within result set 62.

Assume for another example that user 40 is a bisexual male and a member of the swingers website (e.g., website 56). Further, assume that user 40 is a non-smoking, non-drinking, non-using male who is interested in a sexual encounter with another bisexual male.

Accordingly, user 40 may enter a search request in a search screen (not shown) effectuated by data process 10 and included within of the swingers website (e.g., website 56). For the following example, assume that user 40 define a search request seeking a single, bisexual male that prefers non-smokers/non-drinkers/non-users and seeks encounters with another single, bisexual male that is located within the State of Florida.

Data process 10 may receive the above-described search request from user 40 and may compare the above-described search criteria (e.g., a single, bisexual male that prefers non-smokers/non-drinkers/non-users and seeks encounters with another single, bisexual male that is located within the State of Florida) to a plurality of user profiles (e.g., the user profiles included within the swingers website (e.g., website 56) including, but not limited to, user profiles 208. 210) and a plurality of aliases (e.g., the aliases included within the swingers website (e.g., website 56) including, but not limited to, aliases 212, 214, 216, 218) to generate a result set (e.g., result set 62) of user profiles/aliases. Assume for illustrative purposes that alias 212 is included within result set 62.

Data process 10 may provide result set 62 to the user requesting the search (e.g., user 40) so that e.g., user 40 may review the user profiles/aliases (e.g., alias 212) included within result set 62 to determine whether they would like to initiate contact with any of the people identified within result set 62.

As discussed above, while data process 10 is described above as generating 104 two profiles (e.g., profiles 208, 210 for users 36, 58 (respectively) that are linked together as a couple), this is for illustrative purposes only, as other configurations are possible and are considered to be within the scope of this disclosure. For example, data process 10 may be configured to generate 104 a “couple” user profile that describes the two individuals (e.g., user 36, 58) that are included in the couple. Accordingly, while alias 212 is described above as being associated with a user profile for an individual (e.g., user 36), this is for illustrative purposes only, as other configurations are possible and are considered to be within the scope of this disclosure. For example, alias 212 may be associated with a “couple” user profile that describes the two individuals (e.g., user 36, 58) that are included in the couple.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

A number of implementations have been described. Having thus described the disclosure of the present application in detail and by reference to embodiments thereof, it will be apparent that modifications and variations are possible without departing from the scope of the disclosure defined in the appended claims.

What is claimed is:

1. A computer-implemented method, executed on a computing system, comprising:
rendering 106 an alias configuration window for defining an alias that is linked to/associated with a user profile for a user of a dating website;
receiving 108 one or more alias selections from the alias configuration window concerning the alias that is linked to/associated with the user profile for the user of the dating website; and
generating 110 the alias that includes the one or more alias selections received from the alias configuration window.

2. The computer-implemented method of claim 1 further comprising:
rendering 100 a profile configuration window for defining the user profile for the user of the dating website.

3. The computer-implemented method of claim 2 further comprising:
receiving 102 one or more profile selections from the profile configuration window concerning the user profile for the user of the dating website.

4. The computer-implemented method of claim 3 further comprising:
generating 104 the user profile that includes the one or more profile selections received from the profile configuration window.

5. The computer-implemented method of claim 1 wherein the dating website is a swinger's website.

6. The computer-implemented method of claim 1 wherein the user profile defines a group of people.

7. The computer-implemented method of claim 1 wherein the user profile defines a single person.

8. A computer program product residing on a computer readable medium having a plurality of instructions stored thereon which, when executed by a processor, cause the processor to perform operations comprising:
rendering 106 an alias configuration window for defining an alias that is linked to/associated with a user profile for a user of a dating website;
receiving 108 one or more alias selections from the alias configuration window concerning the alias that is linked to/associated with the user profile for the user of the dating website; and
generating 110 the alias that includes the one or more alias selections received from the alias configuration window.

9. The computer program product of claim 8 further comprising instructions for:
rendering 100 a profile configuration window for defining the user profile for the user of the dating website.

10. The computer program product of claim 9 further comprising instructions for:
receiving 102 one or more profile selections from the profile configuration window concerning the user profile for the user of the dating website.

11. The computer program product of claim 10 further comprising instructions for:
generating 104 the user profile that includes the one or more profile selections received from the profile configuration window.

12. The computer program product of claim 8 wherein the dating website is a swinger's website.

13. The computer program product of claim 8 wherein the user profile defines a group of people.

14. The computer program product of claim 8 wherein the user profile defines a single person.

15. A computing system including a processor and memory configured to perform operations comprising:
rendering 106 an alias configuration window for defining an alias that is linked to/associated with a user profile for a user of a dating website;
receiving 108 one or more alias selections from the alias configuration window concerning the alias that is linked to/associated with the user profile for the user of the dating website; and
generating 110 the alias that includes the one or more alias selections received from the alias configuration window.

16. The computing system of claim 16 further configured to perform operations comprising:
rendering 100 a profile configuration window for defining the user profile for the user of the dating website.

17. The computing system of claim 16 further configured to perform operations comprising:
receiving 102 one or more profile selections from the profile configuration window concerning the user profile for the user of the dating website.

18. The computing system of claim 17 further configured to perform operations comprising:
generating 104 the user profile that includes the one or more profile selections received from the profile configuration window.

19. The computing system of claim 15 wherein the dating website is a swinger's website.

20. The computing system of claim 15 wherein the user profile defines a group of people.

21. The computing system of claim 15 wherein the user profile defines a single person.
